(19) United States
(12) Patent Application Publication
(10) Pub. No.: US 2025/0168369 A1
(43) Pub. Date: May 22, 2025

(54) NEURAL NETWORK-BASED ADAPTIVE IMAGE AND VIDEO COMPRESSION METHOD WITH VARIABLE RATE

(71) Applicant: Bytedance Inc., Los Angeles, CA (US)

(72) Inventors: Semih Esenlik, San Diego, CA (US); Zhaobin Zhang, San Diego, CA (US); Kai Zhang, San Diego, CA (US); Li Zhang, San Diego, CA (US)

(21) Appl. No.: 19/033,120

(22) Filed: Jan. 21, 2025

Related U.S. Application Data
(63) Continuation of application No. PCT/US2023/028170, filed on Jul. 19, 2023.
(60) Provisional application No. 63/390,614, filed on Jul. 19, 2022.

(51) Int. Cl. H04N 19/192; H04N 19/124; H04N 19/159; H04N 19/184

(52) U.S. Cl. CPC H04N 19/192; H04N 19/124; H04N 19/159; H04N 19/184

(57) ABSTRACT

A mechanism for processing video data is in a neural network disclosed. The mechanism includes obtaining quantized residual latent samples. The quantized residual latent samples are processed to obtain processed quantized residual latent samples. A reconstructed latent sample can then be acquired based on the processed quantized residual latent sample.

### CROSS-REFERENCE TO RELATED PATENT APPLICATIONS

This patent application is a continuation of International Patent Application No. PCT/US2023/028170, filed on Jul. 19, 2023, which claims the priority to and benefit of U.S. Provisional Patent Application No. 63/390,614, filed Jul. 19, 2022. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data in a neural network comprising: obtaining a quantized residual latent sample; performing a first processing on the quantized residual latent sample; and acquiring a reconstructed latent sample based on the processed quantized residual latent sample.

A second aspect relates to a method for processing video data in a neural network comprising: acquiring a residual latent sample; performing a second processing on the residual latent sample; and quantized the processed residual latent sample to acquire a quantized residual latent sample.

A third aspect relates to an apparatus for processing video data comprising: a processor; and a non-transitory memory with instructions thereon, wherein the instructions upon execution by the processor, cause the processor to perform any of the preceding aspects.

A fourth aspect relates to a non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fifth aspect relates to a non-transitory computer-readable recording medium storing a bitstream by a method of any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRA WINGS

For a more complete understanding of this disclosure, reference is now made to the following brief description, taken in connection with the accompanying drawings and detailed description, wherein like reference numerals represent like parts.

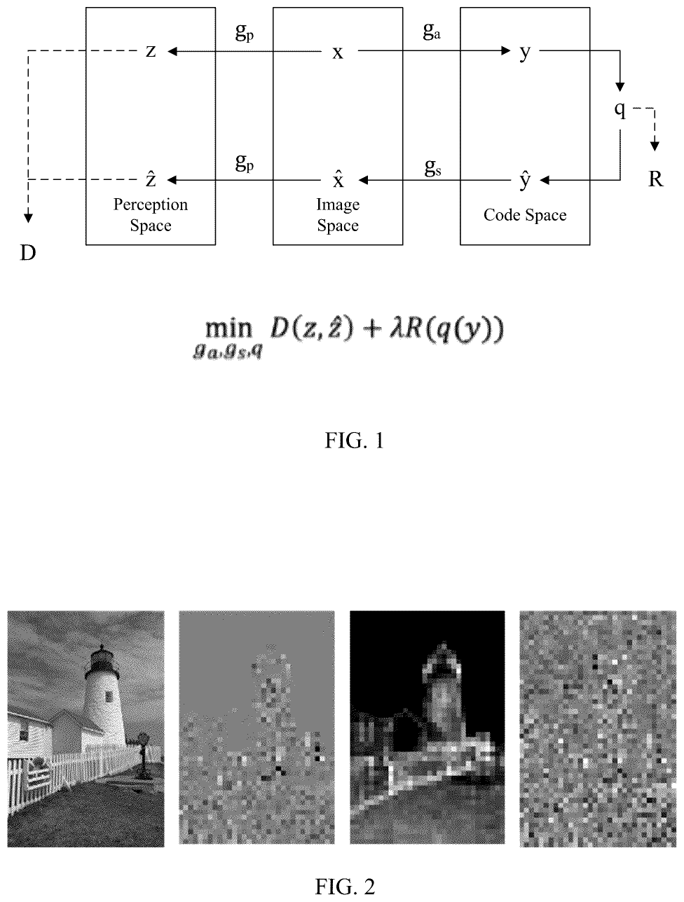

FIG. 1 illustrates an example of a transform coding scheme.

FIG. 2 illustrates an example of a quantized latent when hyper encoder/decoder are used.

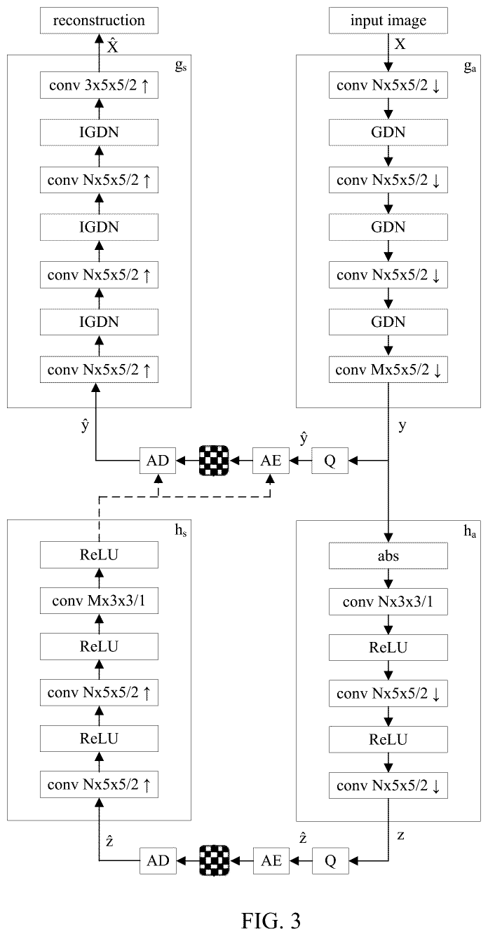

FIG. 3 illustrates an example of a network architecture of an autoencoder implementing a hyper prior model.

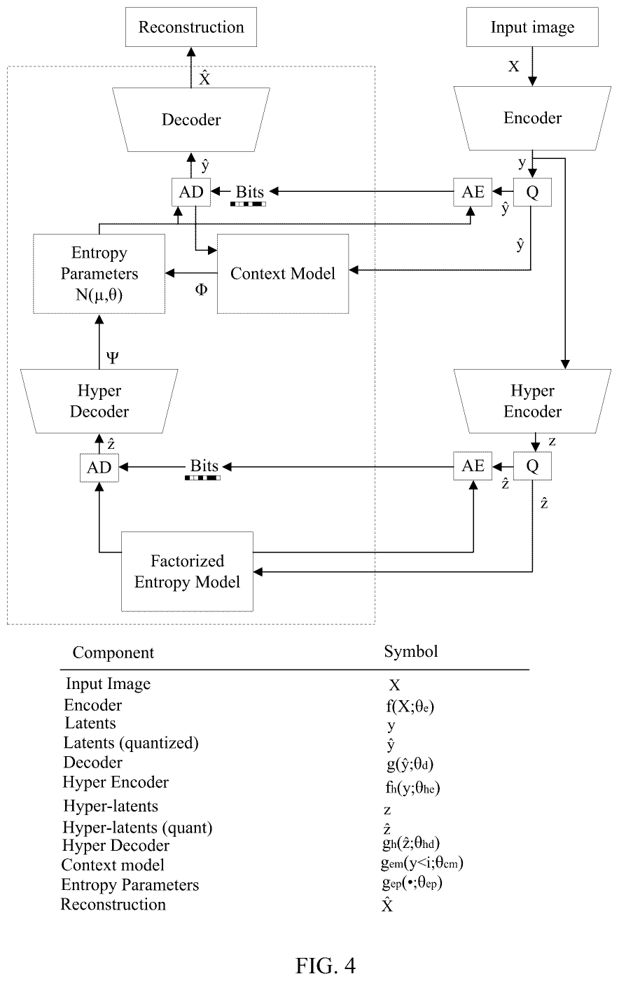

FIG. 4 illustrates a combined model jointly optimizing an autoregressive component that estimates the probability distributions of latents from their causal context (e.g., context model) along with a hyper prior and the underlying autoencoder.

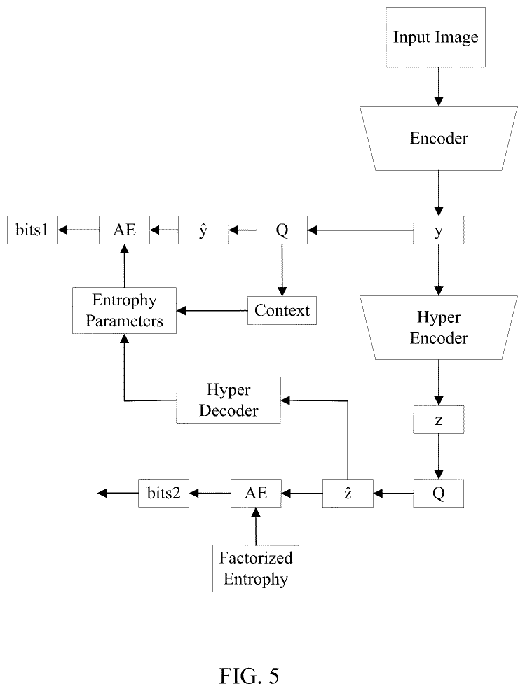

FIG. 5 illustrates an example encoding process utilizing a hyper encoder and a hyper decoder.

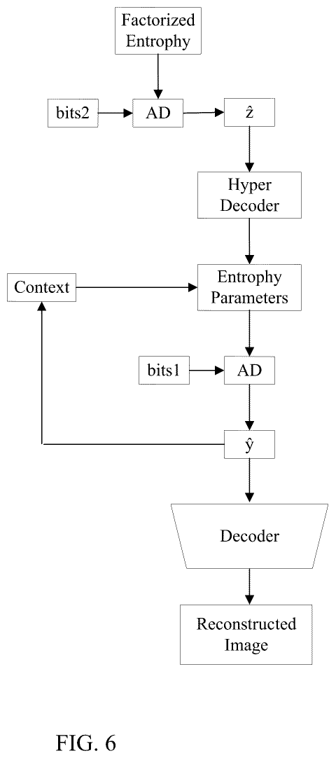

FIG. 6 illustrates an example decoding process.

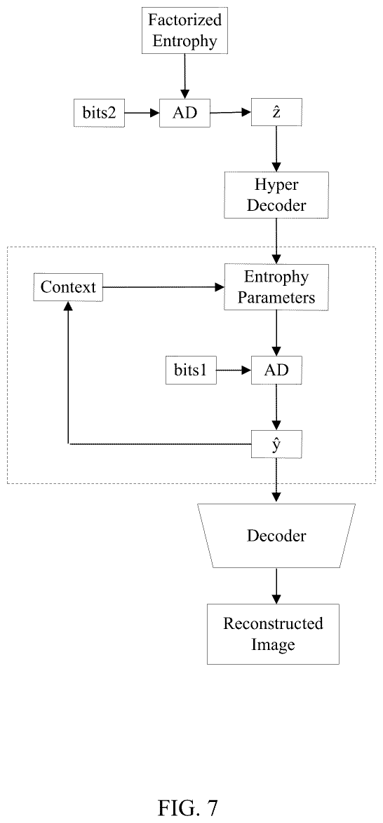

FIG. 7 illustrates the problem in the decoder network.

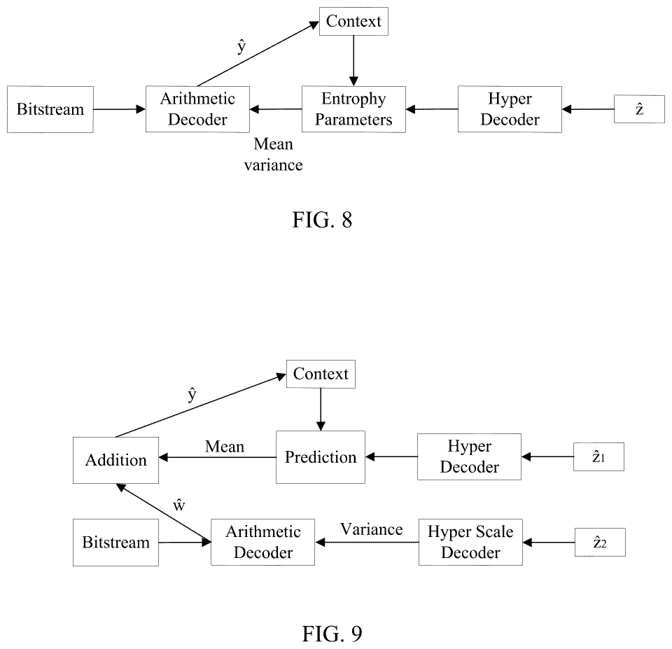

FIG. 8 illustrates an example entropy coding subnetwork in an image decoding architecture.

FIG. 9 illustrates a decoding process according to the present disclosure.

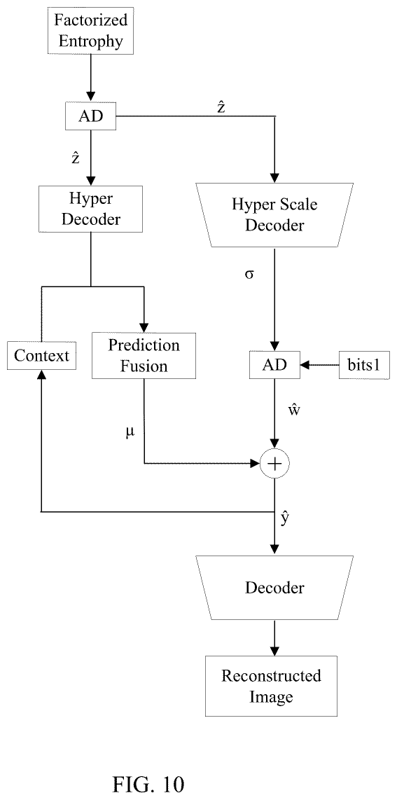

FIG. 10 illustrates an encoding process according to the present disclosure.

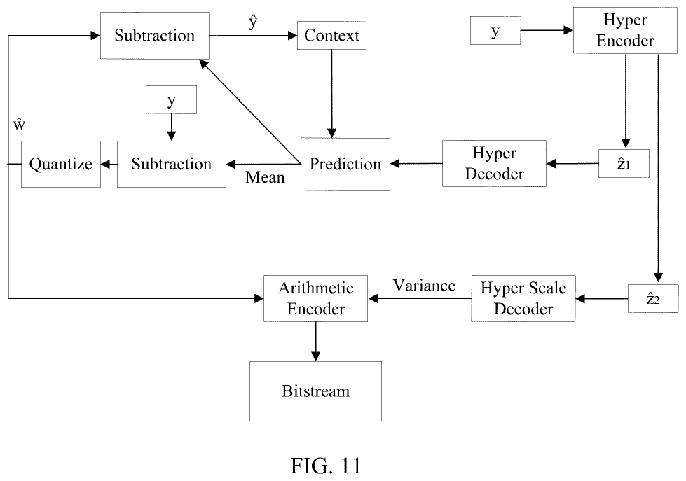

FIG. 11 illustrates an encoding process according to the present disclosure.

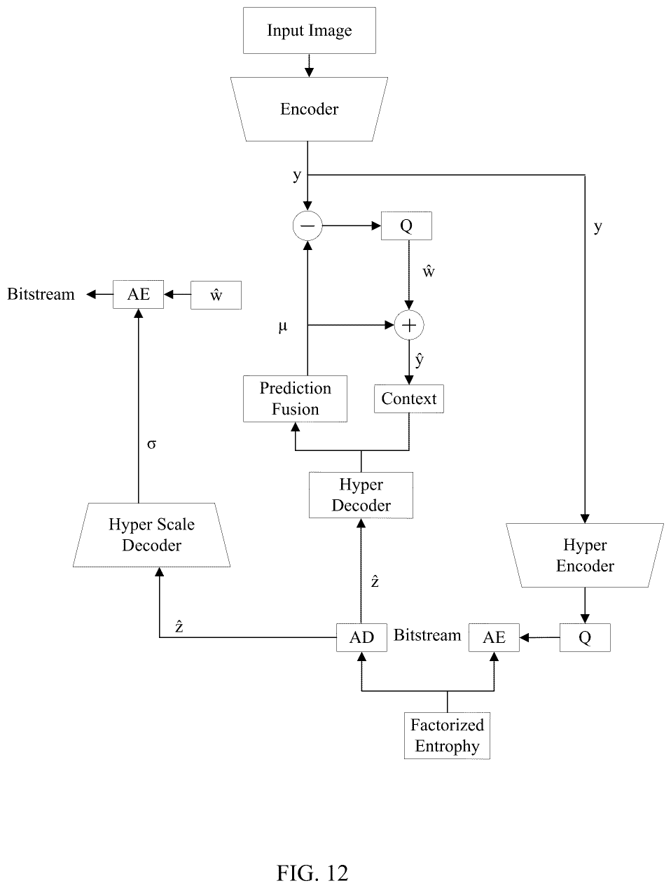

FIG. 12 illustrates an encoding process according to the present disclosure.

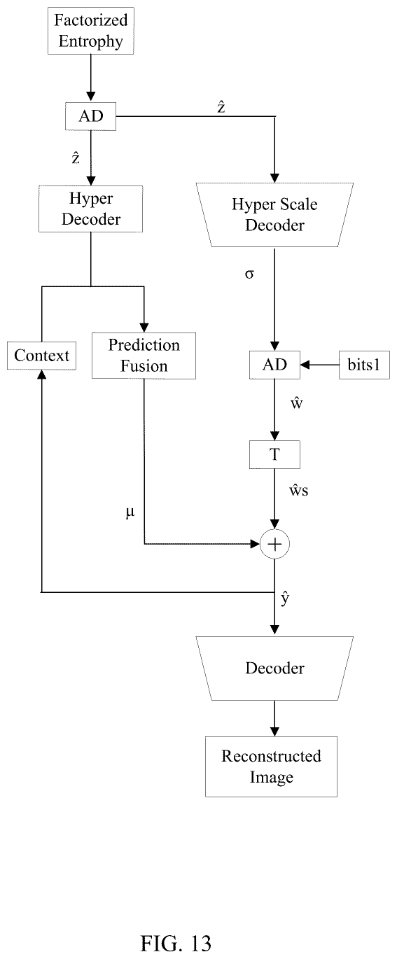

FIG. 13 illustrates an embodiment of a coding device.

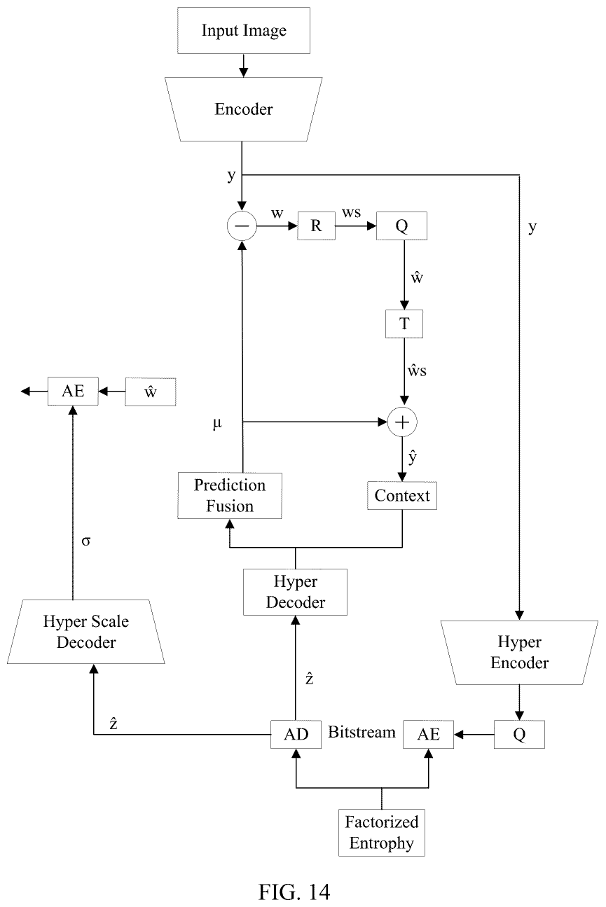

FIG. 14 illustrates an embodiment of a coding device.

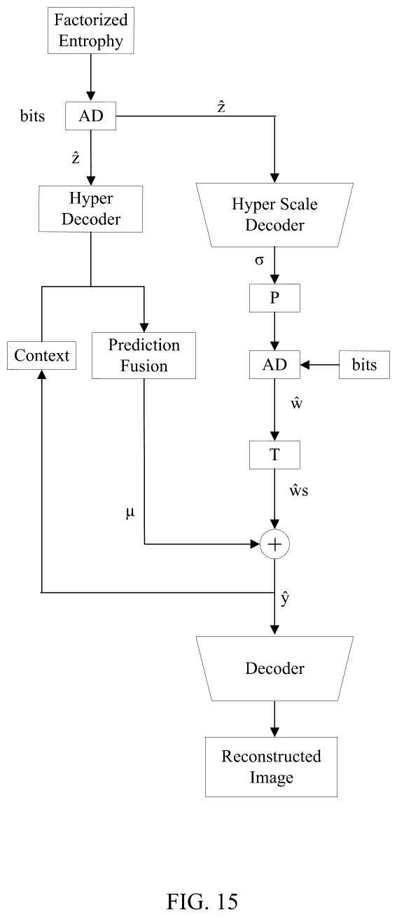

FIG. 15 illustrates an embodiment of a coding device.

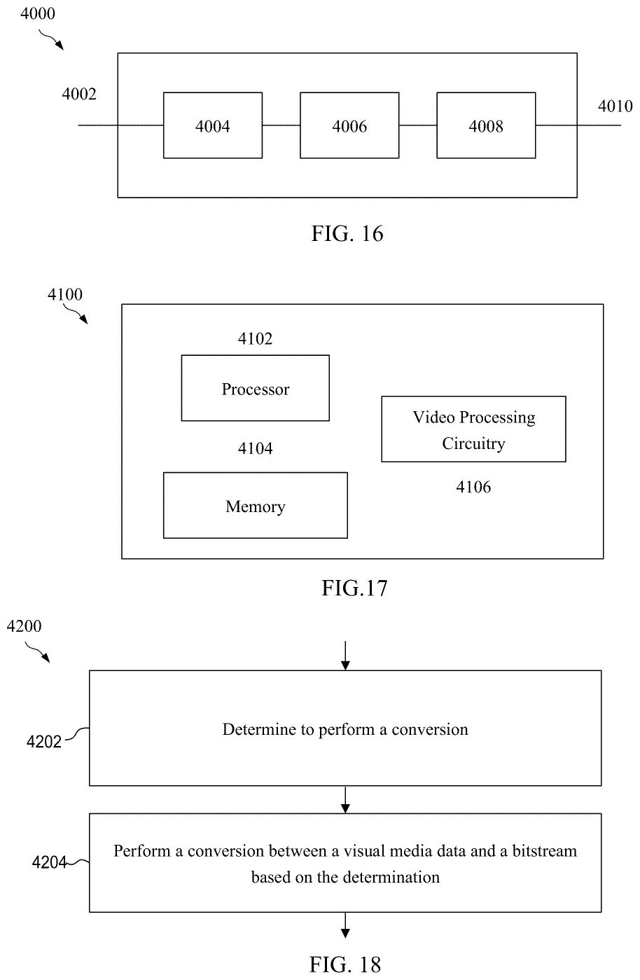

FIG. 16 is a block diagram showing an example video processing system.

FIG. 17 is a block diagram of an example video processing apparatus.

FIG. 18 is a flowchart for an example method of video processing.

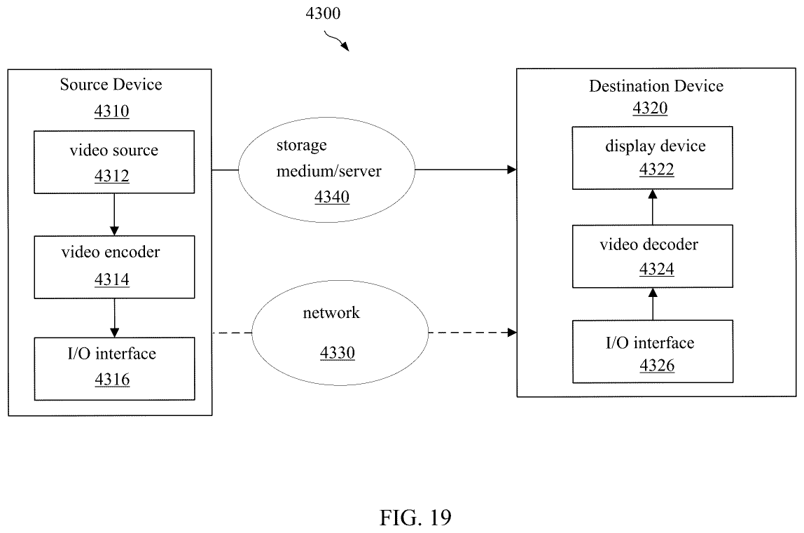

FIG. 19 is a block diagram that illustrates an example video coding system.

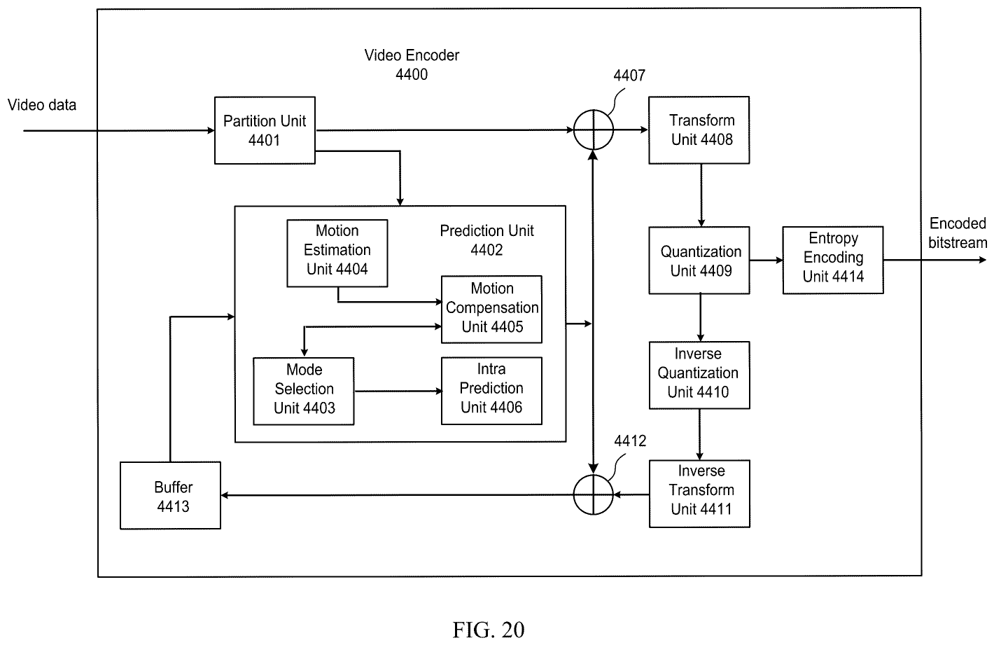

FIG. 20 is a block diagram that illustrates an example encoder.

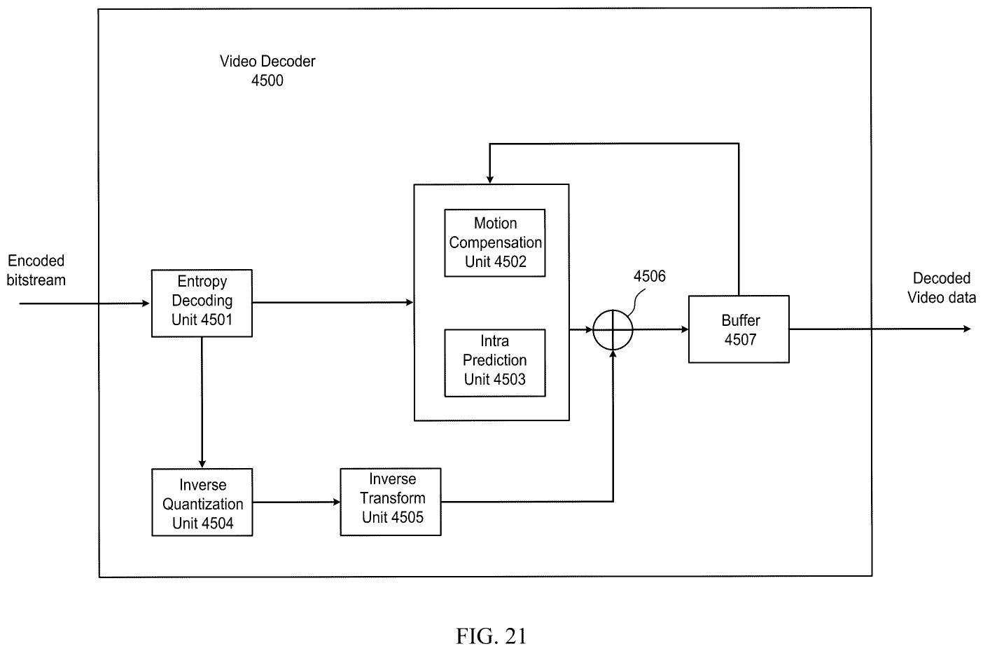

FIG. 21 is a block diagram that illustrates an example decoder.

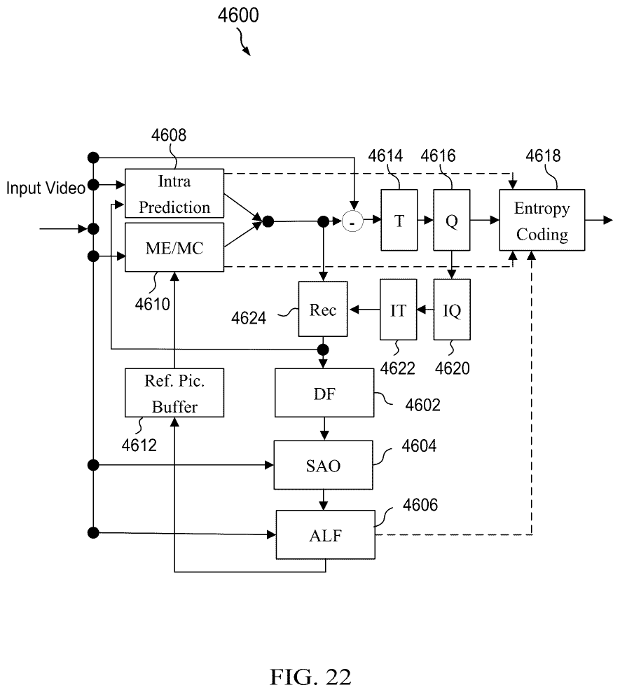

FIG. 22 is a schematic diagram of an example encoder.

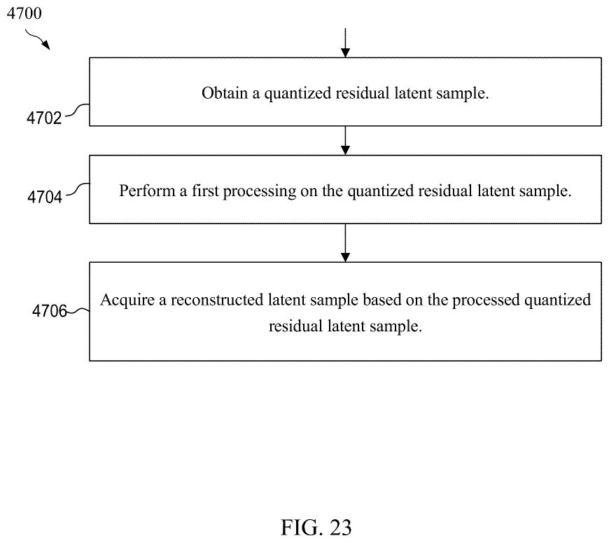

FIG. 23 is a flowchart for an example method of video processing.

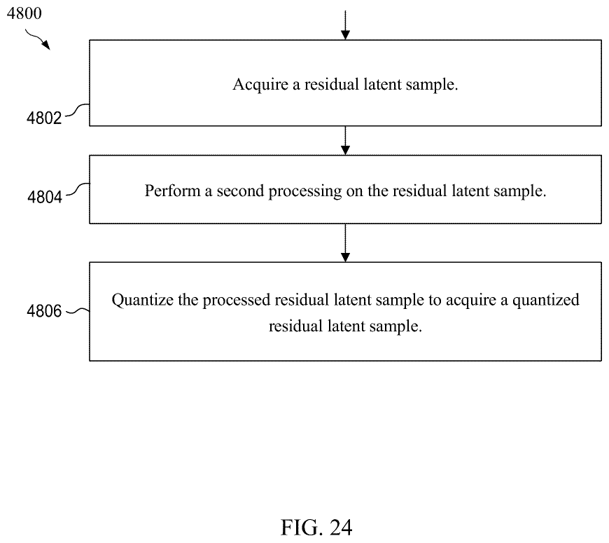

FIG. 24 is a flowchart for an example method of video processing.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, the techniques described herein are applicable to other video codec protocols and designs.

### 1. Summary

A neural network based image and video compression method comprising an auto-regressive subnetwork and an entropy coding engine, wherein entropy coding is performed independently of the auto-regressive subnetwork.

### 2. Background

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half-decade. It is reported that the latest neural network-based image compression algorithm [1] achieves comparable rate distortion (R-D) performance with Versatile Video Coding (VVC) [2], the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1 Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., discrete cosine transform (DCT) or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations International Organization for Standardization (ISO)/International Electrotechnical Commission (IEC) has two expert groups namely Joint Photographic Experts Group (JPEG) and Moving Picture Experts Group (MPEG), and International Telecommunication Union-Telecommunication Standardization Sector (ITU-T) also has its own Video Coding Experts Group (VCEG) which is for standardization of image/video coding technology. The influential video coding standards published by these organizations include JPEG, JPEG 2000, H.262, H.264/advanced video coding (AVC) and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new technique since there were a number of researchers working on neural network-based image coding [3]. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory [6], the optimal method for lossless coding can reach the minimal coding rate −log₂ p(x) where p(x) is the probability of symbol x. A number of lossless coding methods were developed in literature and among them arithmetic coding is believed to be among the optimal ones [7]. Given a probability distribution p(x), arithmetic coding ensures that the coding rate to be as close as possible to its theoretical limit −log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red, green, blue (RGB) color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p (xᵢ) given its context x₁, x₂, . . . , xᵢ₋₁. In [7], the pixel probability is proposed for binary images, i.e., xᵢ∈{−1, +1}. The neural autoregressive distribution estimator (NADE) is designed for pixel probability modeling, where is a feed-forward network with a single hidden layer. A similar work is presented in [8], where the feed-forward network also has connections skipping the hidden layer, and the parameters are also shared. Both [7] and [8] perform experiments on the binarized Modified National Institute of Standards and Technology (MNIST) dataset. See, for example, MNIST dataset: http://yann.lecun.com/exdb/mnist/. In [9], NADE is extended to a real-valued model real valued neural autoregressive density estimator (RNADE), where the probability p (xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) [10] instead of sigmoid. In [11], NADE and RNADE are improved by using reorganizing the order of the pixels and with deeper neural networks.

Designing advanced neural networks plays an important role in improving pixel probability modeling. In [10], multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images later in [13]. Several different neural networks are studied, including RNNs and convolutional neural networks (CNNs) namely PixelRNN and PixelCNN, respectively. In PixelRNN, two variants of LSTM, called row LSTM and diagonal BiLSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1, . . . , 255) and predict a multinomial distribution over the discrete values; they deal with color images in RGB color space; they work well on large-scale image dataset ImageNet. In [14], Gated PixelCNN is proposed to improve the PixelCNN, and achieves comparable performance with PixelRNN but with much less complexity. In [15], PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. In [16], PixelSNAIL is proposed, in which casual convolutions are combined with self-attention.

Most of the compression methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder originates from the well-known work proposed by Hinton and Salakhutdinov [17]. The method is trained for dimensionality reduction and includes two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

FIG. 1 illustrates an example of a transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges. First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(y). The framework is trained with the rate-distortion loss function, i.e., L=D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

In terms of network structure, recurrent neural networks (RNNs) and convolutional neural networks (CNNs) are the most widely used architectures. In the RNNs relevant category, Toderici et al. [18] propose a general framework for variable rate image compression using RNN. They use binary quantization to generate codes and do not consider rate during training. The framework indeed provides a scalable coding functionality, where RNN with convolutional and deconvolution layers is reported to perform decently. Toderici et al. [19] then proposed an improved version by upgrading the encoder with a neural network similar to PixelRNN to compress the binary codes. The performance is reportedly better than JPEG on Kodak image dataset using multi-scale structural similarity index measure (MS-SSIM) evaluation metric. Johnston et al. [20] further improve the RNN-based solution by introducing hidden-state priming. In addition, an SSIM-weighted loss function is also designed, and spatially adaptive bitrates mechanism is enabled. They achieve better results than Better Portable Graphics (BPG) on Kodak image dataset using MS-SSIM as evaluation metric. Covell et al. [21] support spatially adaptive bitrates by training stop-code tolerant RNNs.

Ballé et al. [22] proposes a general framework for rate-distortion optimized image compression. The use multiary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which includes a linear mapping followed by a nonlinear parametric normalization. The effectiveness of GDN on image coding is verified in [23]. Ballé et al. [24] then propose an improved version, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, Ballé et al. [25] improve the method by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. D. Minnen et al. [26] further exploit the structures in the residue space by introducing an autoregressive model to estimate both the standard deviation and the mean. In the latest work [27], Z. Cheng et al. use Gaussian mixture model to further remove redundancy in the residue. The reported performance is on par with VVC [28] on the Kodak image set using PSNR as evaluation metric.

### 2.3.3 Hyper Prior Model

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

FIG. 2 illustrates an example of a quantized latent when hyper encoder/decoder are used. As evident from the middle left and middle right image of FIG. 2, there are significant spatial dependencies among the elements of ŷ. Notably, their scales (middle right image) appear to be coupled spatially. In [25] an additional set of random variables \hat{z} are introduced to capture the spatial dependencies and to further reduce the redundancies. In this case, the image compression network is depicted in FIG. 3.

FIG. 3 illustrates an example of a network architecture of an autoencoder implementing a hyper prior model. In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.

In FIG. 2, an image from the Kodak dataset is shown on the left; the visualization of the latent representation y of that image is shown on the middle left; the standard deviations σ of the latent are shown on the middle right; and latents y after the hyper prior (hyper encoder and decoder) network are shown on the right.

FIG. 3 illustrates a network architecture of an autoencoder implementing the hyper prior model. The left side shows an image of an autoencoder network, the right side corresponds to the hyper prior subnetwork. The analysis and synthesis transforms are denoted as gₐ and gₛ, respectively. Q represents quantization (Q), and AE, AD represent arithmetic encoder (AE) and arithmetic decoder (AD), respectively. The hyper prior model includes two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitstream and transmitted to the receiver (decoder) along with ŷ.

### 2.3.4 Context Model

Although the hyper prior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to the process. For example, the context model subnetwork generates one sample of a latent, which is later used as input to obtain the next sample.

The authors in utilize a joint architecture where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean u and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 4 illustrates the combined model jointly optimizing an autoregressive component that estimates the probability distributions of latents from their causal context (Context Model) along with a hyper prior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically, the latent samples are modeled as gaussian distribution or gaussian mixture models (not limited to). In [26] and according to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 the Encoding Process Using Joint Auto-Regressive Hyper Prior Model

FIG. 4 corresponds to a compression method that is proposed in [26]. In this section and the next, the encoding and decoding processes will be described separately.

FIG. 5 illustrates the encoding process according to that utilizes a hyper encoder and a hyper decoder. In FIG. 5, the encoding process is depicted. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. The latent y is input to hyper encoder, which outputs the hyper latent (denoted by z). The hyper latent is then quantized (2) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In [26] the entropy parameters module are used to estimate the mean and the variance values.

The subnetwork hyper decoder generates part of the information used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process.

It is noted that the other names can be used for the modules described above.

In the above description, the all of the elements in FIG. 5 are collectively the encoder. The analysis transform that converts the input image into latent representation is also called an encoder (or auto-encoder).

FIG. 6 illustrates the decoding process corresponding to [26]. FIG. 6 depicts the decoding process separately corresponding to [26].

### 2.3.6. The Decoding Process Using Joint Auto-Regressive Hyper Prior Model

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1 Low-Latency

[29] are the first to propose a video compression scheme with trained neural networks. They first split the video sequence frames into blocks and each block will choose one from two available modes, either intra coding or inter coding. When intra coding is selected, there is an associated auto-encoder to compress the block. When inter coding is selected, motion estimation and compensation are performed with tradition methods and a trained neural network will be used for residue compression. The outputs of auto-encoders are directly quantized and coded by the Huffman method.

Chen et al. [31] propose another neural network-based video coding scheme with PixelMotionCNN. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme [34]. This scheme performs on par with H.264.

Lu et al. [32] propose the real-sense end-to-end neural network-based video compression framework, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

Rippel et al. [33] propose an advanced neural network-based video compression scheme. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in multi-scale structural similarity (MS-SSIM) than HEVC reference software.

J. Lin et al. [36] propose an extended end-to-end neural network-based video compression framework based on [32]. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than [32] and H.265 by a noticeable margin in terms of both peak signal-to-noise ratio (PSNR) and MS-SSIM.

Eirikur et al. [37] propose scale-space flow to replace commonly used optical flow by adding a scale parameter based on framework of [32]. It is reportedly achieving better performance than H.264.

Z. Hu et al. [38] propose a multi-resolution representation for optical flows based on [32]. Concretely, the motion estimation network produces multiple optical flows with different resolutions and let the network to learn which one to choose under the loss function. The performance is slightly improved compared with [32] and better than H.265.

### 2.4.2 Random Access

Wu et al. [30] propose a neural network-based video compression scheme with frame interpolation. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

Djelouah et al. [41] propose a method for interpolation-based video compression, wherein the interpolation model combines motion information compression and image synthesis, and the same auto-encoder is used for image and residual.

Amirhossein et al. [35] propose a neural network-based video compression method based on variational auto-encoders with a deterministic encoder. Concretely, the model includes an auto-encoder and an auto-regressive prior. Different from previous methods, this method accepts a group of pictures (GOP) as inputs and incorporates a 3D autoregressive prior by taking into account of the temporal correlation while coding the latent representations. It provides comparative performance as H.265.

### 2.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use luma, blue projection, red projection (YUV) color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, [ [symbol] ]=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM) [4].

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate) [5]. There are other important aspects to evaluate image/video coding schemes, including encoding/decoding complexity, scalability, robustness, and so on.

### 3. Problems are Discussed

### 3.1 the Core Problem

Many image compression networks include an autoregressive model (for example the context model) to improve the compression performance. However autoregressive model is interleaved with the inherently serial entropy decoding process, as a result the decoding process becomes inherently serial (cannot be efficiently parallelized) and very slow.

FIG. 7 illustrates the problem in the decoder network, which is highlighted in the dashed box. The problem pertains to the entropy decoding part of the state-of-the-art image decoding architecture. FIG. 7 depicts the state-of-the-art decoder design. The modules on the right hand side, that are encapsulated in the dashed rectangle are responsible for entropy decoding of the quantized latent ŷ. This part is very slow in some architectures due to their serial nature.

FIG. 8 illustrates an example entropy coding subnetwork in an image decoding architecture. In the image decoding architecture according to [26], the process of reconstructing the quantized latent ŷ is performed as follows.

1. The quantized hyper latent \hat{z} is processed by hyper decoder to generate a first partial information. The first partial information is fed to entropy parameters module.

2. The following operation is performed serially and in a recursive manner to reconstruct a sample of the quantized latent ŷ[i, j].

a. The context module generates second partial information using the samples ŷ[m, n], wherein i. n<j, or ii. m<i if n is equal to j. The samples located at [m, n] are the ones that are already reconstructed.

a. Using the first and the second partial information, the Entropy parameter module generates the μ[i, j] and σ[i, j], which are the mean and variance of gaussian probability distribution.

b. Arithmetic decoder decodes the sample ŷ[i, j] from the bitstream using the probability distribution, whose mean and variance are μ[i, j] and σ[i, j]

After the quantized latent ŷ is reconstructed according to the above flow chart, it is processed by a synthesis transform (the decoder) to obtain the reconstructed picture. The synthesis transform is called decoder according to the notation used in [26]. The whole process described above (that includes reconstruction of the ŷ and reconstruction of the image) is also called decoding or a decoder.

In the above a sample of quantized latent is denoted by ŷ[i, j]. It is noted that the sample is not necessarily a scalar value, it might be a vector and might contain multiple elements. In the rest of the application a sample can be denoted by ŷ[i, j] or ŷ[:, i, j]. In the latter, the “:” is used to denote that there is a third dimension and is used to stress that the sample has multiple elements.

After the samples of the quantized latent ŷ are reconstructed, the synthesis transform (i.e. decoder) is performed to obtain the reconstructed image.

As it is apparent from the above description, the arithmetic decoding operation and the Context module operation form a fully serial operation for the decoding of ŷ[i, j]. This means that the samples of ŷ cannot be reconstructed in parallel, they need to be reconstructed one after the other.

The arithmetic decoding process (not limited to arithmetic coding, includes most of the other entropy coding methods such as range coding), is an operation that is computationally simple but inherently sequential. The reason is that, the bitstream includes series of bits, and the bits need to be decoded one by one. This process is suitable to be performed by a processing unit that is fast, like a CPU.

On the other hand the Context and Entropy Parameters modules are computationally intensive and highly parallelizable operations. They are more suitable to be performed by a processing unit that is massively parallel, like a graphics processing units (GPU).

The problem arises in the state-of-the-art image coding architectures, when the context and entropy parameters modules are interleaved with the arithmetic decoding. As described in the flowchart above, the decoding of one sample of ŷ requires application of context module, entropy parameters module followed by the arithmetic decoding module. The context module and entropy parameters modules are deep neural networks, which means that they include huge amount of operations. The arithmetic decoding is a relatively simple operation, however it is fully serial. Performing the fully serial arithmetic decoding operation interleaved with the complex “context” and “entropy parameters” operations slows down the decoding process significantly.

As a first example, if the processes of context, arithmetic decoding and entropy parameters modules are performed in a GPU the following happens.

1. First a sample of quantized latent is obtained using the arithmetic decoding. Since arithmetic decoding is fully serial, only a single core of the GPU is utilized. During this time all of the other GPU cores (there can be thousand cores in a GPU), will be waiting idle. Furthermore each core of the GPU is slow, since they are not designed to perform computations fast.

2. Once a sample of the quantized latent is obtained, the context and entropy parameters modules are performed utilizing multiple cores of the GPU. This second step can be performed efficiently, since the context and entropy parameters modules are suitable for massive parallelization, hence suitable to be performed at a GPU.

3. Go to step 1 till all samples of the quantized latent are decoded.

Once can understand that the source of slow-down is step 1 when the decoding is performed on a GPU.

As a second example, if the processes of context, arithmetic decoding and entropy parameters modules are performed on a CPU the following happens.

1. First a sample of quantized latent is obtained using the arithmetic decoding. Since arithmetic decoding is fully serial, the CPU is very suitable, therefore the sample is obtained very quickly.

2. Once a sample of the quantized latent is obtained, the context and entropy parameters modules are performed. However the CPU is not suitable for performing huge number of operations, it only includes several processing cores. Therefore this step will be very slow.

3. Go to step 1 till all samples of the latent are decoded.

When the process is performed on a CPU, the slow-down is caused by step 2, which is not suitable to be performed on a CPU.

Finally as a third example, one can think about performing part of decoding on CPU (arithmetic decoding) and part on GPU (context and entropy parameters). In this case the following happens.

1. First a sample of latent is obtained using the arithmetic decoding. Since arithmetic decoding is fully serial, the CPU is very suitable, therefore the sample is obtained very quickly. During this time GPU is staying idle.

2. The obtained data is transferred to GPU.

3. Once a sample of the latent is obtained, the context and entropy parameters modules are performed utilizing multiple cores of the GPU. This second step can be performed efficiently, since the context and entropy parameters modules are suitable for massive parallelization, hence suitable to be performed at a GPU. During this time CPU is staying idle.

4. The obtained data (mean and variance values) are sent to CPU.

5. Go to step 1 till all samples of the latent are decoded.

As one can understand, using CPU and GPU in tandem is also not viable due to the idle CPU and GPU times, as well as the times necessary for transferring data back and forth between CPU and GPU. In fact this is the slowest implementation among the 3 options.

In short, the problem arises when computationally complex but massively parallelizable process (such as a deep neural network, e.g. context module or entropy parameters module), needs to be performed in an interleaved fashion with an entropy coding process (such as arithmetic coding or range coding) that is simple but fully serial. The state-of-the-art image coding networks as in [26] or [1] suffer from this problem, hence the decoding process is very slow in this architecture.

A straightforward solution to the above described problem would be to remove the auto-regressive “context” module, as a result the loop comprising the arithmetic decoder, context and entropy parameters module could be eliminated. However this would result in considerable amount of degradation in compression efficiency. The present disclosure achieves the same result as the straightforward solution without sacrificing the compression efficiency.

### 4. The Present Disclosure

The detailed techniques herein should be considered as examples to explain general concepts. These techniques should not be interpreted in a narrow way. Furthermore, these techniques can be combined in any manner.

### 4.1. Target of the Present Disclosure

The target of the present disclosure is to de-interleave the arithmetic decoding process and the computationally complex deep neural network operations. In other words, the target of the present disclosure is to decouple the arithmetic decoding process from the neural network-based modules. Therefore the arithmetic decoding process can be completed independently, without requiring input from neural network based processes. As a result the speed of decoding is increased significantly.

### 4.2. Core of the Present Disclosure

### 4.2.1. Decoding Process

FIG. 9 illustrates a decoding process according to the present disclosure.

According to the present disclosure, the decoding operation is performed as follows.

1. Firstly, a second subnetwork is used to estimate probability parameters using a quantized hyper latent (\hat{z}₂ in FIG. 9).

2. The probability parameters (e.g. variance) generated by the second network are used to generate a quantized residual latent (denoted ŵ in the figures) by performing the arithmetic decoding process. The arithmetic decoder decodes the received bitstream based on the said probability parameters and generates the ŵ.

3. The following steps are performed in a loop until all elements of ŷ are obtained.

a. A first subnetwork is used to estimate a mean value parameter of a quantized latent (ŷ), using the already obtained samples of ŷ.

b. The quantized residual latent ŵ and the mean value are used to obtain the next element of ŷ.

4. After all of the samples of ŷ are obtained, a synthesis transform, such as the decoder module in FIG. 7 can be applied to obtain the reconstructed image.

An example implementation of the disclosure is depicted in the FIG. 9 (the decoding process). In FIG. 9, the first subnetwork comprises the context, prediction and optionally the hyper decoder modules. The second network comprises the hyper scale decoder module. The quantized hyper latent is [symbol] . Compared to the example implementation shown in FIG. 7, the arithmetic decoding process is removed from the loop comprised of arithmetic decoding, context and entropy parameters. Instead, according to the present disclosure the arithmetic decoding process is performed without using any input from context and entropy parameters module, therefore it can be performed independently (it is deinterleaved). According to the present disclosure the arithmetic decoding module has two inputs, the bitstream and the probability parameters (e.g. variance) which are the output of the hyper scale decoder. The hyper scale decoder generates the probability parameters using the quantized hyper latent [symbol] . The arithmetic decoding process generates the quantized residual latent ŵ.

After the residual latent is obtained, a recursive prediction operation is performed to obtain the latent ŷ. The samples of latent ŷ[:, i, j] are obtained as follows.

1. An autoregressive context module is used to generate first input of a prediction module using the samples ŷ[:, m, n] where the (m, n) pair are the indices of the samples of the latent that are already obtained.

2. Optionally the second input of the prediction module is obtained by using a hyper decoder and a quantized hyper latent [symbol] .

3. Using the first input and the second input, the prediction module generates the mean value mean[:, i, j].

4. The mean value mean[:, i, j] and the quantized residual latent ŵ[:, i, j] are added together to obtain the latent ŷ[:, i, j].

5. The steps 1-4 are repeated for the next sample.

FIG. 10 illustrates an encoding process according to the present disclosure. Compared to the FIG. 9, in FIG. 10 the same quantized hyper latent is used as input to the hyper decoder and hyper scale decoder modules. The rest of the operations are same as explained above.

Whether to and/or how to apply at least one method disclosed in the document may be signaled from the encoder to the decoder, e.g. in the bitstream.

Alternatively, whether to and/or how to apply at least one method disclosed in the document may be determined by the decoder based on coding information, such as dimensions, color format, etc.

### 4.2.2. Encoding Process

FIG. 11 illustrates an encoding process according to the present disclosure. According to the present disclosure, the encoding operation is performed as follows.

Initially an analysis transform, such as the encoder in FIG. is applied to obtain all samples of the latent y.

1. First, the following steps are performed in a loop until all elements of quantized residual latent ŵ are obtained.

a. A first subnetwork is used to estimate a mean value parameter of the latent y, using the already obtained samples of quantized latent ŷ.

b. The mean value is subtracted from y to obtain the residual w, which is quantized to obtain quantized residual latent ŵ.

c. ŵ is added to the mean value are added to obtain the quantized latent ŷ.

2. Secondly, a second subnetwork is used to estimate probability parameters (e.g. variance) using a quantized hyper latent \hat{z}.

3. The probability parameters are used by the entropy encoder module to encode elements of the quantized residual latent into the bitstream.

An exemplary implementation of the present disclosure is depicted in the FIG. 11 (the encoding process). In FIG. 11, the first subnetwork comprises the context, prediction and optionally hyper decoder modules. The second network comprises the hyper scale decoder module. Compared to the state of the art (FIG. 5), the arithmetic encoding process is removed from the loop comprised of arithmetic encoding, context and entropy parameters. Instead according to the present disclosure, the arithmetic encoding process is performed without using any input from context and entropy parameters module, therefore it can be performed independently (it is deinterleaved). According to the present disclosure the arithmetic encoding module has two inputs, the quantized residual latent and the probability parameters (e.g. variance) which are the output of the hyper scale decoder. The arithmetic encoding process uses a probability model that has a mean of zero. The hyper scale decoder generates the probability parameters using the hyper latent [symbol] . The arithmetic encoding process generates the bitstream that is transmitted to the decoder.

The samples of the quantized residual latent ŵ[:, i, j] are obtained according to a recursive prediction operation as follows.

1. An autoregressive context module is used to generate first input of a prediction module using the samples ŷ[:, m, n] where the (m, n) pair are the indices of the samples of the latent that are already obtained.

2. Optionally the second input of the prediction module is obtained by using a hyper decoder and a hyper latent [symbol] .

3. Using the first input and the second input, the prediction module generates the mean value mean[:, i, j].

4. The mean value mean[:, i, j] is subtracted from the latent y[:, i, j] to obtain the residual latent w[:, i, j].

5. Residual latent is quantized to obtain quantized residual latent ŵ[:, i, j].

6. ŵ[:, i, j] is added to mean[:, i, j] to obtain the next sample of the quantized latent ŷ[:, i, j]. The steps 1-5 are repeated for the next sample.

Once all of the samples of the quantized residual latent ŵ are obtained according to the recursive process above, the entropy encoding process is applied to convert ŵ to bitstream. A second subnetwork (hyper scale decoder) is used to estimate the probability parameters that are used in the entropy encoding process.

FIG. 12 illustrates an encoding process according to the present disclosure. Compared to the FIG. 11, in FIG. 12 the same quantized hyper latent is used as input to the hyper decoder and hyper scale decoder modules. The rest of the operations are same as explained above.

### 4.3 Some of the Differences Between the State of the Art and the Present Disclosure

There are at least three differences between the state of the art and the present disclosure.

1. The arithmetic encoding and decoding is performed independently of the autoregressive subnetwork (first subnetwork). This way, the fully sequential arithmetic encoding/decoding process can be performed by a processing unit that is fast like a CPU. A new subnetwork (second subnetwork) is introduced to estimate the probability parameters that are used by arithmetic encoding/decoding process.

2. The arithmetic encoding/decoding process are used to encode/decode the quantized latent residual, instead of the quantized latent as in state of the art.

3. The autoregressive subnetwork is used only to estimate the mean of the latent. In the state of the art, it is used to estimate the mean and variance of a gaussian distribution, which is then used by arithmetic encoder and decoder to encode/decode the samples of quantized latent.

### Benefits of the Present Disclosure

The benefits of the present disclosure are at least as follows.

1. The entropy decoding (e.g. arithmetic decoding) process, which is a simple but fully serial operation, can be performed independently. For example, entropy decoding process can be performed by a processing unit that is suitable for performing serial operations quickly, such as a CPU. Once the operation of entropy decoding is complete, the obtained data (quantized residual latent) can be transferred to a GPU.

2. The computationally heavy but easily parallelizable modules (such as context and entropy parameters modules) can be performed independently of arithmetic encoding/decoding. For example a processing unit that is suitable for massive parallel processing (like a GPU) can be used to perform these operations.

3. The idle processing times are eliminated.

According to the present disclosure, the CPU and GPU can be used in tandem. As example the decoding process can be performed as follows.

1. First perform and complete the entropy decoding process. The whole process is completed, and all samples of the quantized latent residual are obtained.

2. Transfer the obtained data to GPU. The data transfer happens only once.

3. Perform and complete the context and entropy parameters modules by the GPU. No idle waiting happens in GPU. The quantized latent is obtained.

4. Perform the synthesis transform (the decoder). The reconstructed image is obtained.

Compared to the third example in section 3.2, the present disclosure eliminates back-and-forth data transfer between CPU and GPU when both CPU and GPU are used for decoding. Moreover it eliminates idle waiting times.

In fact, the present disclosure can achieve an impressive 10 times speed-up in the decoding. Moreover with the help of the clever design, it does not suffer from any degradation in compression efficiency.

### 4.6 Example Embodiments of the Present Disclosure

The detailed embodiments of the present disclosure described below should be considered as examples to explain general concepts. These embodiments should not be interpreted in a narrow way. Furthermore, these embodiments can be combined in any manner.

1. In one example, more than one subnetwork may be utilized as hyper encoders/decoders for hyper information.

a. In one example, at least one subnetwork is utilized to generate hyper information which is depended by the parsing process for the latent information.

b. In one example, at least one subnetwork is utilized to generate hyper information which is NOT depended by the parsing process for the latent information.

c. In one example, at least one subnetwork is utilized to generate hyper information which is used to predict the latent signal.

d. In one example, the hyper information may comprise statistical information or probability distribution information for the latent signal which may be quantized.

i. The statistical information or probability distribution information may comprise the mean value of the latent signal.

ii. The statistical information or probability distribution information may comprise the variance of the latent signal.

2. In one example, the latent signal may be coded in a predictive way.

a. In one example, y′=y−p may be coded at encoder where y is a latent sample and p is the prediction.

i. Correspondingly, y*=y′+p may be reconstructed at decoder.

b. In one example, y may be quantized before the prediction procedure.

c. In one example, y may not be quantized before the prediction procedure.

d. In one example, p may be quantized before the prediction procedure.

e. In one example, p may not be quantized before the prediction procedure.

f. In one example, y′ may be quantized after the prediction procedure.

g. In one example, y′ may not be quantized after the prediction procedure.

h. In one example, at least one subnetwork may be utilized to generate the prediction p.

i. In one example, at least one previously decoded y* or y′ may be utilized to generate the prediction p for the current y or y*.

Embodiments with variable rate capability.

According to the present disclosure the residual latent w can be processed before quantization in the encoder. FIG. 14 illustrates an embodiment of a coding device. For example, an encoder design according to the present disclosure is exemplified in FIG. 14. According to the present disclosure, firstly the residual latent is obtained by subtracting the prediction samples μ (a.k.a the mean values), from latent samples y. Then the residual latent samples are processed by a module R, whose input is w and whose output is ws. Instead of the residual samples, processed residual samples ws are quantized to obtain quantized residual samples ŵ. The quantized residual samples are then included in a bitstream. Afterwards the ŵ are further modified by a module T (in FIG. 14), to obtain [symbol] , which is added to the prediction samples to obtain the latent samples ŷ.

The modules R and T are used in tandem in the encoder before and after the quantization to adjust the magnitude of the residual samples. Therefore, the amount of information included in the bitstream can be achieved. For example, if the module R reduces the magnitude of the residual samples, the bitrate necessary to encoding the residual samples will be reduced. Therefore, the size of the bitstream, that is required to encode the residual samples will reduce, hence the compression ratio will be increased. On the other hand increasing the compression ratio will reduce the quality of the compressed image. Therefore, the module R can be used to control the compression ratio, which is an important feature that is required for compression systems.

The module T in FIG. 14 works in a way that is opposite of module R. If the module R generally reduces the magnitude of the residual samples, the module T counteracts by increasing intensity of the quantized residual samples. Therefore, the magnitude of the latent samples ŷ can on average stay the same.

FIG. 13 illustrates an embodiment of a coding device. In the decoder (FIG. 13), the module T that is implemented in encoder might also be implemented. An example implementation is depicted in FIG. 13. First the quantized residual samples ŵ are obtained from the bitstream. Afterwards ŵ is processed by module T to obtain the processed quantized residual samples [symbol] . Processed quantized residual samples are then added to the prediction samples to obtain the latent samples ŷ.

The process performed by module R and T might be a sample-wise multiplication with a vector. Sample wise multiplication process can be performed as:

$$O [ i ] = T [ i ] \times v [ i ]$$

According to the formula above, the i'th element of the output O is obtained by multiplying the i'th element of the vectors T and v. Similarly, in the FIGS. 13 and 14, processed quantized residual samples [symbol] might be obtained as:

$$[ i ] = T [ i ] \times \hat{w} [ i ]$$

where the ŵ is the quantized residual samples, and T is the vector that processes the ŵ.

In the encoder in FIG. 14 the processing module R can be applied in a similar way to obtain the processed residual samples ws, as element wise multiplication:

$$ws [ i ] = R [ i ] \times w [ i ]$$

The difference between ws and [symbol] is, the latter are quantized samples (obtained after a quantization process).

The process T can also be performed according to follows:

$$[ i ] = T 1 [ i ] \times \hat{w} [ i ] + T 2 [ i ]$$

where the i'th element of the output [symbol] is obtained by multiplying the i'th element of the vectors T1 and i'th element of the quantized residual sample and adding the i'th sample of the vector T2.

According to one example, the samples of the processed quantized residual samples can be obtained according to:

$$[ i ] = T [ K ] [ i ] \times \hat{w} [ i ]$$

where K is an index value, that determines the index of the processing vector T [K] that is used to process the quantized residual samples. In other words, the value of K can be used to determine which vector (out of a set of possible vectors) is used to process the quantized residual samples.

According to the present disclosure, an indication might be included in the bitstream to indicate which vector out of a set of vectors is used to process the quantized residual samples.

According to the present disclosure, the processed quantized residual samples [symbol] can be obtained according to the equation:

$$[ i , x , y ] = T [ K ] [ i ] \times \hat{w} [ i , x , y ]$$

According to the equation above samples of processed quantized residual sample whose location is given by 3 indices i, x and y is obtained by multiplying quantized residual samples ŵ[i,x,y], with the processing vector T[K]. According to one example implementation, at least a first sample of the processed quantized residual sample [symbol] is obtained according to a first vector T[K], and at least a second sample of [symbol] is obtained according to a second vector T[M]. The samples of [symbol] are then used to obtain the latent samples ŷ, which are then processed by a transform to obtain the reconstructed image.

According to the present disclosure, at least 2 indication are included in the bitstream to indicate the index of at least two processing vectors, T1 and T2. The T1 and T2 are used to process the quantized residual samples ŵ to obtain [symbol] . [symbol] is later added to prediction samples u to obtain latent samples ŷ. Latent samples are then processed by a transform to obtain the reconstructed image.

According to one example, the latent samples ŷ are divided into at least 2 tiles. Tiles are rectangular partitions of the latent samples. A first processing vector T1 is used to obtain the samples of [symbol] , which are then used to obtain the samples of ŷ that correspond to the first tile. And a second processing vector T2 is used to obtain the samples of [symbol] , which are then used to obtain the samples of ŷ that correspond to the second tile. Additionally or alternatively, two indications might be included in the bitstream to indicate which processing vector corresponds to first tile and which vector corresponds to second tile.

Additionally or alternatively, samples of probability parameters σ might be processed by a module P. The module P can be performed similarly to the modules T and R that are exemplified above (e.g. sample-wise multiplication with a vector).

FIG. 15 illustrates an embodiment of a coding device implemented according to the present disclosure. In the FIG. 15, the probability parameters σ are processed by a first module P. The processed probability parameters are used to obtain the quantized residual samples ŵ. ŵ is then processed by a second module T to obtain processed quantized residual samples, which are then used to obtain ŷ and hence the reconstructed image.

The reason of applying both the P module on probability parameters and the T module on quantized residual samples is that, the modification of quantized residual samples results in different statistical properties. Therefore, it might be inefficient to estimate the statistical properties of the modified residual samples using the unmodified probability parameters. Therefore according to the present disclosure the probability parameters are also modified by module P to align for the modification on quantized residual samples.

According to the present disclosure, one indication might be included in the bitstream to select the processing vector T (which is used to modify the quantized residual samples) and the processing vector P that modifies the probability parameters σ. In other words, a single index value might be used to determine which vector P and which vector T are going to be used.

At decoder side the residual \hat{r} is scaled by Inverse Gain Unit (section F.4) according to the parameter β, producing \hat{r}′. Then resildual tensor is scaled in invRVS (Inverse Residual and Variance Scale) module (section G.3) forming residual tensor \hat{r}″. This is used for reconstructed latent tensor ŷ.

### D.4 Sigma Scale

This process is applied both at encoder and decoder sides, and so normative.

The input of this process
forward gain vector m (derived as described in F.2);
standard deviation tensor σ of size [C, h₄, w₄], which is an output of Hyper Scale Decoder (D.3).
   The output of this process
scaled by forward gain vector standard deviation tensor σ′ of size [C, h₄, w₄], which goes to the adaptive sigma scale (G.3.3).

Sigma scale modifies standard deviation tensor σ[C, h₄, w₄] as an input and output standard deviation tensor multiplied by gain vector:

$${σ}^{′} [ c , i , j ] = m [ c ] \cdot σ [ c , i , j ] ;$$

$$i = 0 , … , {h}_{4} - 1 , j = 0 , … , {w}_{4} - 1 , c = 0 , … , C - 1 .$$

All elements of the tensor in the same channel are scaled by the same multiplier.

### F.3 Gain Unit

This process is applied at encoder side only and so it is non-normative process, described here to simplify explanation of normative inverse gain unit (F.4) and sigma scale (F.5) processes.
The input of this process
forward gain vector m (derived as described in F.2);
residual tensor r of size [C, h₄, w₄], which is the result of subtraction mean value from latent tensor r=y−μ.
   The output of this process
scaled by forward gain vector residual tensor r′ of size [C, h₄, w₄]
   On encoder side a gain unit is placed after a residual calculation (FIG. 4.4-2). An output scaled residual tensor is equal to the input tensor multiplied by gain vector in a channel dimension:

$${r}^{′} [ c , i , j ] = ( m [ c ] \cdot r [ c , i , j ] ) ≫ ( gainVectorPrecison + extraMultiplierPrecison ) ;$$

$$0 \leq i < {h}_{4} , 0 \leq j < {w}_{4} , 0 \leq c < C .$$

All elements of the tensor in the same channel are scaled by the same multiplier.

### F.4 Inverse Gain Unit

This process is applied at decoder side and so normative.
The input of this process
inverse gain vector m⁻¹ (derived as described in F.2);
reconstructed residual tensor \hat{r} of size [C, h₄, w₄], which is the output of decoder-side SKIP process (G.4.3).
   The output of this process
scaled by inverse gain vector residual tensor [symbol] of size [C, h₄, w₄] (which later goes to the inverse residual scale process G.3.4).

On decoder side an inverse gain unit is placed after entropy decoder and takes reconstructed residual as an input (FIG. 4.5-2). The output is reconstructed residual tensor multiplied by inverse gain vector:

$$[ c , i , j ] = ( {m}^{- 1} [ c ] \cdot \hat{r} [ c , i , j ] ) \cdot {2}^{( gainVectorPrecision + extraMultiplierPrecision )} ;$$

$$0 \leq i < {h}_{4} , 0 \leq j < {w}_{4} , 0 \leq c < C .$$

All elements of the tensor in the same channel are scaled by the same multiplier.

### F.2 Control Parameters and Gain Vector Derivation

In total four models are trained for different range of quality. Model is selected base on modelIdx coded at Picture header. Rate control parameter β controls compression ratio and defines operations in Gain Unit, Inverse Gain Unit and Sigma Scale (marked as sGain in FIG. 4.4-2 and FIG. 4.5-2).
The forward gain vector m is used at encoder side in Gain Unit, and at encoder and decoder in sigma scale (sGain).
The inverse gain vector m⁻¹ is used at decoder side in Inverse Gain Unit. Both forward m and inverse m⁻¹ gain vectors have size[C] equal to the number of channels of residual tensor.
Learnable model includes pairs of reference forward and inverse gain vectors {mₜ, mₜ⁻¹} which correspond β∈{βₜ}.
Elements of vector mₜ are 6 bit values.
The input of gain vector derivation process is
10-bits variable β_{displacement} equal to beta_displacement_y for primary and to beta_displacement_uv for secondary component;
reference forward and inverse gain vectors {mₜ, mₜ⁻¹} and corresponding β∈{βₜ}.
   The output of gain vector derivation process is
forward gain vector m;
inverse gain vectorm⁻¹.
   The gain vectors are computed by simple scale process:

$$m = {m}_{t} \cdot {β}_{displacement} ; {m}^{- 1} = {m}_{t}^{- 1} \cdot 1 / {β}_{displacement} .$$

In further computations extraMultiplierPrecision=5, gainVectorPrecision=5.

| model_header( ) { | Descriptor |
|---|---|
| independent_beta_uv | u(1) |
| beta_displacement_y | u(10) |
| if( independent_beta_uv ) | |
| beta_displacement_uv | u(10) |
| model_id | u(2) |
| opIdx | u(1) |
| core_model_header( ) | |
| coding_mode_header( ) | |
| color_transform_header( ) | |

The following references are incorporated herein by reference as if reproduced in their entirety:
[1] Z. Cheng, H. Sun, M. Takeuchi and J. Katto, “Learned image compression with discretized gaussian mixture likelihoods and attention modules,” in Proceedings of the IEEE/CVF Conference on Computer Vision and Pattern Recognition, pp. 7939-7948, 2020.
[2] B. Bross, J. Chen, S. Liu and Y.-K. Wang, “Versatile Video Draft (Draft 10),” JVET-S2001, July 2020.
[3] R. D. Dony and S. Haykin, “Neural network approaches to image compression,” Proceedings of the IEEE, vol. 83, no. 2, pp. 288-303, 1995.
[4] Z. Wang, A. C. Bovik, H. R. Sheikh, and E. P. Simoncelli, “Image quality assessment: From error visibility to structural similarity,” IEEE Transactions on Image Processing, vol. 13, no. 4, pp. 600-612, 2004.
[5] G. Bjontegaard, “Calculation of average PSNR differences between RD-curves,” VCEG, Tech. Rep. VCEG-M33, 2001.
[6] C. E. Shannon, “A mathematical theory of communication,” Bell System Technical Journal, vol. 27, no. 3, pp. 379-423, 1948.
[7] H. Larochelle and I. Murray, “The neural autoregressive distribution estimator,” in Proceedings of the Fourteenth International Conference on Artificial Intelligence and Statistics, 2011, pp. 29-37.
[8] K. Gregor and Y. LeCun, “Learning representations by maximizing compression,” arXiv preprint arXiv: 1108.1169, 2011.
[9] B. Uria, I. Murray, and H. Larochelle, “RNADE: The real-valued neural autoregressive density-estimator,” in NIPS, 2013, pp. 2175-2183.
[10] L. Theis and M. Bethge, “Generative image modeling using spatial LSTMs,” in NIPS, 2015, pp. 1927-1935.
[11] B. Uria, I. Murray and H. Larochelle, “A deep and tractable density estimator,” in ICML, 2014, pp. 467-475.
[12] I. H. Witten, R. M. Neal, and J. G. Cleary, “Arithmetic coding for data compression,” Communications of the ACM, vol. 30, no. 6, pp. 520-541, 1987.
[13] A. van den Oord, N. Kalchbrenner, and K. Kavukcuoglu, “Pixel recurrent neural networks,” in ICML, 2016, pp. 1747-1756.
[14] A. van den Oord, N. Kalchbrenner, O. Vinyals, L. Espeholt, A. Graves, and K. Kavukcuoglu, “Conditional image generation with PixelCNN decoders,” in NIPS, 2016, pp. 4790-4798.
[15] T. Salimans, A. Karpathy, X. Chen, and D. P. Kingma, “PixelCNN++: Improving the PixelCNN with discretized logistic mixture likelihood and other modifications,” arXiv preprint arXiv: 1701.05517, 2017.
[16] X. Chen, N. Mishra, M. Rohaninejad, and P. Abbeel, “PixelSNAIL: An improved autoregressive generative model,” in ICML, 2018, pp. 863-871.
[17] G. E. Hinton and R. R. Salakhutdinov, “Reducing the dimensionality of data with neural networks,” Science, vol. 313, no. 5786, pp. 504-507, 2006.
[18] G. Toderici, S. M. O'Malley, S. J. Hwang, D. Vincent, D. Minnen, S. Baluja, M. Covell, and R. Sukthankar, “Variable rate image compression with recurrent neural networks,” arXiv preprint arXiv: 1511.06085, 2015.
[19] G. Toderici, D. Vincent, N. Johnston, S. J. Hwang, D. Minnen, J. Shor, and M. Covell, “Full resolution image compression with recurrent neural networks,” in CVPR, 2017, pp. 5306-5314.
[20] N. Johnston, D. Vincent, D. Minnen, M. Covell, S. Singh, T. Chinen, S. Jin Hwang, J. Shor, and G. Toderici, “Improved lossy image compression with priming and spatially adaptive bit rates for recurrent networks,” in CVPR, 2018, pp. 4385-4393.
[21] M. Covell, N. Johnston, D. Minnen, S. J. Hwang, J. Shor, S. Singh, D. Vincent, and G. Toderici, “Target-quality image compression with recurrent, convolutional neural networks,” arXiv preprint arXiv: 1705.06687, 2017.
[22] J. Ballé, V. Laparra, and E. P. Simoncelli, “End-to-end optimization of nonlinear transform codes for perceptual quality,” in PCS. IEEE, 2016, pp. 1-5.
[23] J. Balle, “Efficient nonlinear transforms for lossy image compression,” in ‘PCS, 2018, pp. 248-252.
[24] J. Ballé, V. Laparra and E. P. Simoncelli, “End-to-end optimized image compression,” in International Conference on Learning Representations, 2017.
[25] J. Balle, D. Minnen, S. Singh, S. Hwang and N. Johnston, “Variational image compression with a scale hyperprior,” in International Conference on Learning Representations, 2018.
[26] D. Minnen, J. Balle, G. Toderici, “Joint Autoregressive and Hierarchical Priors for Learned Image Compression”, arXiv.1809.02736. 1, 2, 3, 4, 7
[27] Z.Cheng, H. Sun M. Takeuchi and J. Katto, “Learned image compression with discretized Gaussian mixture likelihoods and attention modules,” in Proceedings of the IEEE/CVF Conference on Computer Vision and Pattern Recognition (CVPR), 2020.
[28] Github repository “CompressAI: https://github.com/InterDigitalInc/CompressAI,”, InterDigital Inc, accessed December 2020.
[29] T. Chen, H. Liu, Q. Shen, T. Yue, X. Cao, and Z. Ma, “DeepCoder: A deep neural network based video compression,” in VCIP. IEEE, 2017, pp. 1-4.
[30] C.-Y. Wu, N. Singhal, and P. Krahenbuhl, “Video compression through image interpolation,” in Proceedings of the European Conference on Computer Vision (ECCV), 2018, pp. 416-431.
[31] Z. Chen, T. He, X. Jin, and F. Wu, “Learning for video compression,” IEEE Transactions on Circuits and Systems for Video Technology, DOI: 10.1109/TCSVT.2019.2892608, 2019.
[32] G. Lu, W. Ouyang, D. Xu, X. Zhang, C. Cai, and Z. Gao, “DVC: An end-to-end deep video compression framework,” in Proceedings of the IEEE/CVF Conference on Computer Vision and Pattern Recognition (CVPR), 2019.
[33] O. Rippel, S. Nair, C. Lew, S. Branson, A. Anderson and L. Bourdev, “Learned Video Compression,” 2019 IEEE/CVF International Conference on Computer Vision (ICCV), Seoul, Korea (South), 2019, pp. 3453-3462, doi: 10.1109/ICCV.2019.00355.
[34] G. Toderici, D. Vincent, N. Johnston, S. J. Hwang, D. Minnen, J. Shor, and M. Covell, “Full resolution image compression with recurrent neural networks,” in CVPR, 2017, pp. 5306-5314.
[35] A. Habibian, T. Rozendaal, J. Tomczak and T. Cohen, “Video Compression with Rate-Distortion Autoencoders,” in Proceedings of the IEEE/CVF International Conference on Computer Vision (ICCV), 2019, pp. 7033-7042.
[36] J. Lin, D. Liu, H. Li and F. Wu, “M-LVC: Multiple frames prediction for learned video compression,” in Proceedings of the IEEE/CVF Conference on Computer Vision and Pattern Recognition (CVPR), 2020.
[37] E. Agustsson, D. Minnen, N. Johnston, J. Balle, S. J. Hwang and G. Toderici, “Scale-Space Flow for End-to-End Optimized Video Compression,” 2020 IEEE/CVF Conference on Computer Vision and Pattern Recognition (CVPR), Seattle, WA, USA, 2020, pp. 8500-8509, doi: 10.1109/CVPR42600.2020.00853.
[38] X. Hu, Z. Chen, D. Xu, G. Lu, W. Ouyang and S. Gu, “Improving deep video compression by resolution-adaptive flow coding,” in European Conference on Computer Vision (ECCV) 2020.
[39] B. Li, H. Li, L. Li and J. Zhang, “A Domain Rate Control Algorithm for High Efficiency Video Coding,” in IEEE Transactions on Image Processing, vol. 23, no. 9, pp. 3841-3854 September 2014, doi: 10.1109/TIP.2014.2336550.
[40] L. Li, B. Li, H. Li and C. W. Chen, “λ Domain Optimal Bit Allocation Algorithm for High Efficiency Video Coding,” in IEEE Transactions on Circuits and Systems for Video Technology, vol. 28, no. 1, pp. 130-142, January 2018, doi: 10.1109/TCSVT.2016.2598672.
[41] Abdelaziz Djelouah, Joaquim Campos, Simone Schaub-Meyer, and Christopher Schroers. Neural inter-frame com-pression for video coding. In ICCV, pages 6421-6429 October 2019.
[42] F. Bossen, Common Test Conditions and Software Reference Configurations, document Rec. JCTVC-J1100, Stockholm, Sweden, July 2012.
[43] N. Kamaci, Y. Altunbasak, and R. M. Mersereau, “Frame bit allocation for the h.264/avc video coder via cauchy-density-based rate and distortion models,” IEEE Transactions on Circuits and Systems for Video Technology, vol. 15, no. 8, pp. 994-1006, 2005.
[44] S. Mallat and F. Falzon, “Analysis of low bit rate image transform coding,” IEEE Transactions on Signal Processing, vol. 46, no. 4, pp. 1027-1042, 1998.

FIG. 16 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 17 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 18 is a flowchart for an example method 4200 of video processing. The method 4200 includes determining to apply a preprocessing function to visual media data as part of an image compression framework at step 4202. A conversion is performed between a visual media data and a bitstream based on the image compression framework at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

FIG. 19 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVM) standard and other current and/or further standards.

FIG. 20 is a block diagram illustrating an example of video encoder 4400, which may be video encoder 4314 in the system 4300 illustrated in FIG. 19. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

FIG. 21 is a block diagram illustrating an example of video decoder 4500 which may be video decoder 4324 in the system 4300 illustrated in FIG. 19. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

FIG. 22 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

FIG. 23 is a flowchart for an example method 4700 of video processing. The method 4700 includes obtaining a quantized residual latent sample at step 4702. A first processing is performed on the quantized residual latent sample at step 4704. A reconstructed latent sample is acquired based on the processed quantized residual latent sample at step 4706. The step 4706 may include encoding at an encoder or decoding at a decoder, depending on the example.

It should be noted that the method 4700 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4700. Further, the method 4700 can be performed by a non-transitory computer readable medium comprising a computer program product for use by a video coding device. The computer program product comprises computer executable instructions stored on the non-transitory computer readable medium such that when executed by a processor cause the video coding device to perform the method 4700.

FIG. 24 is a flowchart for an example method 4800 of video processing. The method 4800 includes acquiring a residual latent sample at step 4802. A second processing on the residual latent sample is performed at step 4804. The processed residual latent sample is quantized at step 4806 to acquire a quantized residual latent sample. Step 4806 may be included as part of encoding at an encoder or decoding at a decoder, depending on the example.

It should be noted that the method 4800 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4700. Further, the method 4800 can be performed by a non-transitory computer readable medium comprising a computer program product for use by a video coding device. The computer program product comprises computer executable instructions stored on the non-transitory computer readable medium such that when executed by a processor cause the video coding device to perform the method 4800.

A listing of solutions preferred by some examples is provided next.

The following solutions show examples of techniques discussed herein.

1. An image decoding method, comprising the steps of: obtaining, the reconstructed latents ŷ[:, :, :] using the arithmetic decoder; the reconstructed latents are fed into the synthesis neural network; based on the decoded parameters for tiled partitioning, at one or multiple locations, the output feature maps are tiled partitioned into multiple parts; each part is separately fed into the next stage of convolutional layers to obtain the output spatially partitioned feature maps; the spatially partitioned feature maps are cropped and stitched back to a whole feature map spatially; proceed until the image is reconstructed.

2. An image encoding method, comprising the steps of: obtain the quantized latents and tiled partitioning parameters; and encode the latents and partitioning parameters into the bitstreams.

3. An apparatus for processing video data comprising: a processor; and a non-transitory memory with instructions thereon, wherein the instructions upon execution by the processor, cause the processor to perform.

4. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-2.

5. A non-transitory computer-readable recording medium storing a bitstream of a video which is generated by a method performed by a video processing apparatus, wherein the method comprises the method of any of solutions 1-2.

6. A method for storing bitstream of a video comprising the method of any of solutions 1-2.

7. A method, apparatus, or system described in the present document.

Another listing of solutions preferred by some examples is provided next.

1. A method for processing video data in a neural network comprising: obtaining quantized residual latent samples (ŵ); processing the quantized residual latent samples ŵ to obtain processed quantized residual latent samples ( [symbol] ); adding the quantized residual latent samples [symbol] to prediction samples (μ) to obtain latent samples (ŷ); and performing a conversion between a visual media data and a bitstream based on the latent samples ŷ.

2. The method of solution 1, further comprising: obtaining residual latent samples (w) by subtracting prediction samples (μ) from latent samples (y); and processing the residual latent samples w to obtain processed residual samples (ws), wherein the processed residual samples ws are quantized to obtain quantized residual latent samples (ŵ).

3. The method of any of solutions 1-2, wherein the residual latent samples w are processed by a gain unit (T), and wherein the quantized residual latent samples ŵ are processed by an inverse gain unit (R).

4. The method of any of solutions 1-3, wherein the inverse gain unit R applies an opposite function as gain unit T.

5. The method of any of solutions 1-4, wherein the inverse gain unit R reduces a magnitude of quantized residual latent samples w, and wherein the gain unit T increases the magnitude of residual latent samples W.

6. The method of any of solutions 1-5, wherein the inverse gain unit R is implemented using sample-wise multiplication according to:

$$[ i , x , y ] = T [ i ] \times \hat{w} [ i , x , y ]$$

where [symbol] [i, x,y] are residual latent samples [symbol] at indices i, x, and y, T is processing vector, T[i] is a sample of the processing vector, and ŵ[i,x,y] are quantized residual latent samples ŵ at indices i, x, and y.

7. The method of any of solutions 1-6, wherein the inverse gain unit R is implemented using sample-wise multiplication according to:

$$[ i , x , y ] = T [ K ] [ i ] \times \hat{w} [ i , x , y ]$$

where [symbol] [i, x,y] are residual latent samples [symbol] at indices i, x, and y, T[K][i] are samples i in processing vectors T[K], and ŵ[i,x,y] are quantized residual latent samples ŵ at indices i, x, and y.

8. The method of any of solutions 1-7, wherein i is an index corresponding to a channel dimension.

9. The method of any of solutions 1-8, wherein x or y are indices corresponding to a horizontal spatial dimension or a vertical spatial dimension.

10. The method of any of solutions 1-9, wherein the gain unit R is implemented using sample-wise multiplication according to:

$$ws [ i , x , y ] = T [ K ] [ i ] \times w [ i , x , y ]$$

where ws [i,x,y] are processed residual latent samples ws at indices i, x, and y, T[K][i] are samples i in processing vectors T[K], and w [i,x,y] are residual latent samples w at indices i, x, and y.

11. The method of any of solutions 1-10, wherein the bitstream includes at least two indications indicating indices of a first processing vector T1 and a second processing vector T2 used in T[K].

12. The method of any of solutions 1-11, wherein K indicates the index of the processing vector.

13. The method of any of solutions 1-12, wherein latent samples y are divided into at least 2 tiles, wherein tiles are rectangular partitions of latent samples, wherein a first processing vector T1 is used to obtain samples of [symbol] , which are then used to obtain samples of ŷ that correspond to a first tile, and wherein a second processing vector T2 is used to obtain the samples of [symbol] , which are then used to obtain the samples of ŷ that correspond to a second tile.

14. The method of any of solutions 1-13, wherein vector T1 is different from vector T2.

15. The method of any of solutions 1-14, wherein a sigma scale unit (P) is applied to probability parameters (o).

16. The method of any of solutions 1-15, wherein probability parameters (σ) are used to obtain quantized residual latent samples.

17. The method of any of solutions 1-16, wherein the sigma scale unit P is implemented using sample-wise multiplication according to:

$$σ s [ i , x , y ] = P [ K ] [ i ] \times σ [ i , x , y ]$$

where σs [i,x,y] are scaled probability parameters σs at indices i, x, and y, P[K][i] are parameters i in processing vectors P[K], and σ [i,x,y] are probability parameters σ indices i, x, and y.

18. The method of any of solutions 1-17, wherein the probability parameters σ are processed by the sigma scale unit P, wherein processed probability parameters σ are used to obtain the quantized residual latent samples ŵ, wherein ŵ is then processed by a second gain unit T to obtain processed quantized residual latent samples [symbol] , which are then used to obtain latent samples ŷ resulting in a reconstructed image.

19. The method of any of solutions 1-18, reconstructed image is obtained by processing of the latent samples with a transform process.

20. The method of any of solutions 1-19, wherein the transform process is an inverse transform or a synthesis transform.

21. The method of any of solutions 1-20, wherein an indication is included in the bitstream to select a processing vector T or a processing vector P, wherein the processing vector T modifies the quantized residual latent samples [symbol] , and the processing vector P modifies the probability parameters σ.

22. The method of any of solutions 1-21, wherein the residual latent sample w are processed before quantization, and wherein quantized residual latent samples ŵ are included in the bitstream.

23. The method of any of solutions 1-22, wherein R and T are used in tandem before and after quantization to adjust magnitude of the residual samples, wherein an amount of information included in the bitstream is achieved, wherein when R reduces a magnitude of the residual samples, the bitrate necessary to encode residual samples is reduced, wherein a size of the bitstream that encodes the residual samples is reduced, wherein compression ratio is increased, wherein increasing a compression ratio reduces a quality of a compressed image, and wherein R is used to control the compression ratio.

24. The method of any of solutions 1-23, wherein when R reduces a magnitude of residual samples, T counteracts by increasing intensity of residual samples, and wherein a magnitude of latent samples ŷ stays the same on average.

25. The method of any of solutions 1-24, wherein first the quantized residual samples ŵ are obtained from the bitstream, afterwards w is processed by T to obtain the processed quantized residual samples [symbol] , processed quantized residual samples [symbol] are then added to prediction samples to obtain the latent samples ŷ.

26. The method of any of solutions 1-25, wherein a process performed by R and T is a sample-wise multiplication with a vector performed as:

$$O [ i ] = T [ i ] \times v [ i ]$$

where an i'th element of the output O is obtained by multiplying an i'th element of the vectors T and v.

27. The method of any of solutions 1-26, wherein a process performed by T is performed as:

$$[ i ] = T [ i ] \times \hat{w} [ i ]$$

where the ŵ is the quantized residual samples, and T is a vector that processes the ŵ.

28. The method of any of solutions 1-27, wherein a process performed by R is performed as

$$ws [ i ] = R [ i ] \times w [ i ]$$

where the w is residual latent samples and R is a vector that processes the w.

29. The method of any of solutions 1-28, wherein a process performed by T is performed as:

$$[ i ] = T 1 [ i ] \times \hat{w} [ i ] + T 2 [ i ]$$

where an i'th element of an output [symbol] is obtained by multiplying an i'th element of vectors T1 and an i'th element of quantized residual samples and adding an i'th sample of the vector T2.

30. The method of any of solutions 1-29, wherein samples of the processed quantized residual samples can be obtained according to:

$$[ i ] = T [ K ] [ i ] \times \hat{w} [ i ]$$

where K is an index value that determines the index of the processing vector T[K] that is used to process the quantized residual samples, and where a value of K is used to determine which vector out of a set of possible vectors is used to process the quantized residual samples.

31. The method of any of solutions 1-30, wherein samples of processed quantized residual sample whose location is given by 3 indices i, x and y are obtained by multiplying quantized residual samples ŵ [i,x,y] with the processing vector T[K], or wherein at least first sample of the processed quantized residual sample [symbol] is obtained according to a first vector T[K], and at least a second sample of [symbol] is obtained according to a second vector T[M], or wherein samples of [symbol] are then used to obtain the latent samples ŷ, which are then processed by an transform to obtain a reconstructed image.

32. The method of any of solutions 1-31, wherein T1 and T2 are used to process the quantized residual samples ŵ to obtain [symbol] , [symbol] is later added to prediction samples u to obtain latent samples ŷ, and latent samples are then processed by a transform to obtain a reconstructed image.

33. The method of any of solutions 1-32, wherein two indications are included in the bitstream to indicate which processing vector corresponds to a first tile and which vector corresponds to a second tile.

34. The method of any of solutions 1-33, wherein applying both P on probability parameters and T on quantized residual samples is performed so modification of quantized residual samples results in different statistical properties, and wherein probability parameters are modified by P to align for modification on quantized residual samples.

35. The method of any of solutions 1-34, wherein a single index value is used to determine which vector P and which vector T are used.

36. A method for processing video data in a neural network comprising: obtaining a sample of a quantized residual latent ŵ using a bitstream and the output of a first subnetwork, wherein the first subnetwork is not autoregressive; obtaining a prediction value mean using a second subnetwork and already reconstructed samples of a quantized latent ŷ; reconstructing the next sample of the quantized latent ŷ using the quantized residual sample ŵ and the prediction mean; and obtaining a reconstructed image using the quantized latent ŷ and a synthesis transform.

37. A method for processing video data in a neural network comprising: transforming an input image using an analysis transform to obtain a latent y; obtaining a prediction value mean, using a second network and already reconstructed samples of a quantized latent ŷ; subtracting the prediction value from a sample of the latent to obtain a residual latent sample w; quantizing the residual latent sample (ŵ) and adding to the prediction value to obtain a sample of the quantized latent ŷ; and obtaining the bitstream using a first subnetwork and the samples of quantized residual latent samples ŵ, wherein the first subnetwork is not auto-regressive.

38. The method of any of solutions 36-37, wherein the first subnetwork takes a first quantized hyper latent as input and generates probability parameters.

39. The method of any of solutions 36-38, wherein obtaining of the sample of a quantized residual latent comprises entropy decoding, wherein the probability parameters and a bitstream is used as input.

40. The method of any of solutions 36-39, wherein obtaining of the bitstream comprises entropy encoding, wherein the probability parameters and quantized residual latent are inputs.

41. The method of any of solutions 36-40, wherein probability parameters do not include a mean value.

42. The method of any of solutions 36-41, wherein a zero mean probability distribution is used in entropy encoding or entropy decoding.

43. The method of any of solutions 36-42, wherein the second subnetwork takes a second quantized hyper latent as input, in addition to the already reconstructed samples of quantized latent.

44. The method of any of solutions 36-43, wherein the first and the second quantized hyper latent are same.

45. The method of any of solutions 36-44, wherein the quantized hyper latent are obtained from a bitstream in the decoder.

46. The method of any of solutions 36-45, wherein the quantized hyper latent are obtained from the latent y or quantized latent ŷ using a subnetwork.

47. The method of any of solutions 36-46, wherein the second subnetwork is autoregressive.

48. The method of any of solutions 36-47, wherein the second subnetwork comprises a context module.

49. The method of any of solutions 36-48, wherein the second subnetwork comprises a hyper decoder module.

50. An apparatus for processing video data comprising: a processor; and a non-transitory memory with instructions thereon, wherein the instructions upon execution by the processor, cause the processor to perform the method of any of solutions 1-49.

51. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-49.

52. A non-transitory computer-readable recording medium storing a bitstream of a video which is generated by a method performed by a video processing apparatus, wherein the method comprises: obtaining quantized residual latent samples (ŵ); processing the quantized residual latent samples ŵ to obtain processed quantized residual latent samples ( [symbol] ); adding the quantized residual latent samples [symbol] to prediction samples (μ) to determine latent samples (ŷ); and generating the bitstream based on the determining.

53. A method for storing bitstream of a video comprising: obtaining quantized residual latent samples (ŵ); processing the quantized residual latent samples ŵ to obtain processed quantized residual latent samples ( [symbol] ); adding the quantized residual latent samples [symbol] to prediction samples (μ) to determine latent samples (ŷ); generating the bitstream based on the determining; and storing the bitstream in a non-transitory computer-readable recording medium.

In the solutions described herein, an encoder may conform to a format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including+10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The solutions listed in the present disclosure might be used for compressing an image, compressing a video, compression part of an image or compressing part of a video.

In addition, techniques, systems, subsystems, and methods described and illustrated in the various embodiments might be used for compressing an image, compressing a video, compression part of an image or compressing part of a video.

What is claimed is:

1. A method for visual data processing comprising:
obtaining a quantized residual latent sample for each component of visual data;
performing a first processing on the quantized residual latent sample to de-scale the quantized residual latent sample to obtain a processed quantized residual latent sample; and
acquiring a reconstructed latent sample based on the processed quantized residual latent sample.

2. The method of claim 1, wherein the method is used for decoding the visual data from a bitstream.

3. The method of claim 1, wherein a residual latent sample is obtained by subtracting a prediction sample of the component from a latent sample of the component, a second processing is performed on the residual latent sample to obtain a processed residual latent sample, and the quantized residual latent sample is obtained based on the processed residual latent sample.

4. The method of claim 3, wherein the first processing is performed by an inverse gain unit and the second processing is performed by a gain unit;
wherein the first processing applies an opposite function as the second processing;
wherein the first processing adjusts a magnitude of the quantized residual latent sample; or wherein the second processing adjusts a magnitude of the residual latent sample.

5. The method of claim 3, wherein the first processing is based on a first processing vector, the second processing is based on a second processing vector, and the first processing vector and the second processing vector satisfy the following:
$$T = 1 / R ,$$
where T is the first processing vector and R is the second process vector.

6. The method of claim 1, wherein the first processing is implemented according to:
$$[ i ] = T [ K ] [ i ] x \times \hat{w} [ i ]$$
where [symbol] [i] indicates the processed quantized residual latent sample, T[K] indicates a first processing vector, T[K][i] indicates an element in the first processing vector corresponding to the quantized residual latent sample, K indicates an index of the first processing vector, ŵ [i] indicates the quantized residual latent sample, and i is an index corresponding to a channel dimension.

7. The method of claim 6, wherein [symbol] [i] is [symbol] [i,x,y], and ŵ [i] is ŵ [i,x,y],
where x is an index corresponding to a horizontal spatial dimension, and y is an index corresponding to a vertical spatial dimension.

8. The method of claim 1, wherein an indication is included in a bitstream to indicate which vector in a set of vectors is used in the first processing.

9. The method of claim 1, further comprising: performing a third processing on a probability parameter to obtain a processed probability parameter;
wherein the processed probability parameter is used to derive the quantized residual latent sample.

10. The method of claim 9, wherein the first processing is based on a first processing vector, the third processing is based on a third processing vector, and the first processing vector is derived from the third processing vector.

11. The method of claim 9, wherein an indication is included in a bitstream to indicate which vector in a first set of vectors is used in the first processing and which vector in a second set of vectors is used in the third processing;
wherein the first processing is performed after obtaining the quantized residual latent sample using the processed probability parameter.

12. The method of claim 1, wherein acquiring the reconstructed latent sample based on the processed quantized residual latent sample, comprises:
processing the processed quantized residual latent sample by an inverse residual and variance scale module;
adding an output of the inverse residual and variance scale module to a prediction sample to obtain the reconstructed latent sample.

13. The method of claim 1, wherein the component is a luma component or a chroma component, and
wherein a reconstructed image is obtained by processing of the reconstructed latent sample with a transform process, wherein the transform process is an inverse transform or a synthesis transform.

14. The method of claim 3, wherein different vectors in the first processing are used for a first sample and a second sample, respectively, and the different vectors in the first processing are respectively based on different indications in a bitstream;
wherein different vectors in the second processing are used for the first sample and the second sample, respectively, and the different vectors in the second processing are respectively based on different indications in the bitstream;
wherein the first sample and the second sample belong to different tiles;
wherein the first sample and the second sample belong to different components;
wherein reconstructed latent samples in the visual data are divided into at least two tiles, and the at least two tiles are rectangular partitions of the reconstructed latent samples.

15. A method for visual data processing comprising:
acquiring a residual latent sample for each component of visual data;
performing a second processing on the residual latent sample to scale the residual latent sample to obtain a processed residual latent sample; and
processing the processed residual latent sample to acquire a quantized residual latent sample.

16. The method of claim 15, wherein the second processing is implemented according to:
$$ws [ i ] = R [ K ] [ i ] \times w [ i ]$$
where ws [i] indicates the processed residual latent sample, R[K] indicates a second processing vector, R[K][i] indicates an element in the second processing vector corresponding to the residual latent sample, K indicates an index of the second processing vector, w [i] indicates the residual latent sample, and i is an index corresponding to a channel dimension.

17. The method of claim 16, wherein ws [i] is ws [i,x,y], and w [i] is w [i,x,y],
where x is an index corresponding to a horizontal spatial dimension, and y is an index corresponding to a vertical spatial dimension.

18. The method of claim 15, wherein the method is used for encoding the visual data into a bitstream.

19. An apparatus for processing visual data comprising: a processor; and a non-transitory memory with instructions thereon, wherein the instructions upon execution by the processor, cause the processor to:
obtain a quantized residual latent sample for each component of visual data;
perform a first processing on the quantized residual latent sample to de-scale the quantized residual latent sample to obtain a processed quantized residual latent sample; and
acquire a reconstructed latent sample based on the processed quantized residual latent sample.

20. An apparatus for processing visual data comprising: a processor; and a non-transitory memory with instructions thereon, wherein the instructions upon execution by the processor, cause the processor to:
acquire a residual latent sample for each component of visual data;
perform a second processing on the residual latent sample to scale the residual latent sample to obtain a processed residual latent sample; and
process the processed residual latent sample to acquire a quantized residual latent sample.
